(19) United States
(12) Patent Application Publication
(10) Pub. No.: US 2013/0004878 A1
(43) Pub. Date: Jan. 3, 2013

(54) Catalytic Burner for Fuel Cell Exhaust Gas

(76) Inventors: Kai Kuchenbuch, Stolberg (DE); Patrick Mangold, Kirchheim (DE); Gert Hinsenkamp, Esslingen (DE)

(21) Appl. No.: 13/579,303

(22) PCT Filed: Dec. 4, 2010
(86) PCT No.: PCT/EP2010/007377

§ 371 Date: Sep. 5, 2012

(30) Foreign Application Priority Data
Feb. 17, 2010 (DE) 10 2010 008 209.0

(51) Int. Cl. H01M 8/04; F23C 13/00; F23D 14/62

(52) U.S. Cl. 429/440; 429/444; 431/354; 431/170

(57) ABSTRACT

A catalytic burner includes a catalyst body and a line element for the supply of a gas mixture to the catalyst body. The catalytic burner also includes a transitional region between the line element and the catalyst body. A swirl element is arranged in the flow region upstream of the catalyst body in the direction of flow.

### BACKGROUND AND SUMMARY OF THE INVENTION

The invention relates to a catalytic burner the application of such a catalytic burner.

Catalytic burners can be used for converting combustible starting materials without an open flame. From the field of fuel cell systems, for example, catalytic burners are known to be used for the after-combustion of residual hydrogen in the exhaust gas and/or for the controlled combustion of hydrogen or another fuel for generating thermal energy. Such catalytic burners generally comprise a catalyst body that may be designed, for example, as a porous or honeycomb-type material, a bed of pellets or the like. The material used in the catalyst body is at least partially provided with a catalytically active material such as platinum, palladium or the like. In order to convert the starting materials used completely by means of such a catalytic burner, which is one of the main aims of using a catalytic burner, in particular in the after-combustion of undesirable residues in exhaust gases or the like, a catalytic burner of a suitable size has to be provided in order to convert all of the combustible materials present in the gas mixture to be burned. This requires a correspondingly large space and a comparably large catalyst body. As the materials that are typically used as catalysts, such as platinum, are very expensive, such a suitably large catalyst body also involves considerable costs.

The length of the catalyst body is related to the uniform distribution of the gas mixture flowing to the catalyst body. If this is improved, a more even conversion can be obtained in the available cross-sectional area of the catalyst body through which the gases can flow, with the result that the catalyst body can be made smaller and therefore more cost-effective. In this context, German Patent Document DE 10 2008 031 060 A1 discloses providing, for an even distribution of an exhaust gas stream, built-in parts extending in the direction of flow in an exhaust pipe to act as baffles which, notwithstanding the frequent bends required in the exhaust pipe for reasons of space, ensure a relatively even distribution of the exhaust gas stream across the entire cross-section of the exhaust pipe. With curved line elements that guide the gas mixture into the region of the catalyst body, this structure provides an improvement, but it nevertheless cannot ensure a sufficiently even flow towards the flow cross-section of the catalyst body that its longitudinal dimension can be reduced in a sustained manner.

U.S. Patent Application Publication No. US 2003/0096204 A1 discloses a catalytic burner in which, unlike the commonly used method of introducing additional fuel via a ring nozzle, a very complex structure is created so that approaching gas and a metered fuel reverse their directions of flow several times in order to obtain a very good intermingling. Suitable intermingled, the gas mixture then flows into the region of the catalyst body. Although a very good intermingling action is achieved here, this structure cannot provide for an even flow to the catalyst body. In addition, owing to a multitude of very small and filigree components, this structure is extremely complex and results in a highly cost-intensive mixing region upstream of the catalyst body.

U.S. Patent Application Publication No. US 2005/0172547 A1 discloses a device for mixing gases in which swirl elements are used in order to mix gas streams independently flowing into the region of the swirl elements.

Exemplary embodiments of the present invention are directed to a catalytic burner which, using a minimum number of components in a simple and compact design, allows as homogeneous an approach to the catalyst body as possible, so that its overall length can be reduced sustainably.

According to exemplary embodiments of the present invention, a swirl element is placed in the region of flow upstream of the catalyst body in the direction of flow. Such a swirl element, which according to a very advantageous further development, can be provided with several guide vanes, ensures irrespective of its minimal space requirements in the direction of flow that both the fuel gas distribution and the velocity profile of the gas mixture across the catalyst body become significantly more uniform in different load conditions. This has been shown clearly in flow simulations. The swirl element, in particular if provided with several guide vanes, fans the flow of the gas mixture upstream of the catalyst body by radial deflection, therefore ensuring a very even and homogeneous approach towards the catalyst body. The gas mixture is therefore distributed across the entire available surface area of the catalyst body with a very homogeneous velocity profile. The catalyst body and the catalytically active material present therein can therefore be exploited ideally, and the catalyst body can be minimized in terms of its space requirements, in particular in terms of the length of the required space. This results in a very compact structure, which further permits significant savings with respect to the generally very expensive catalytically active material.

According to a particularly useful and advantageous further development of the structure according to the invention, the catalyst body is cylindrical in design and the swirl element is arranged centrally with respect to the flow cross-section of the catalyst body. A cylindrical catalyst body offers the advantage that it can easily be integrated into a line element or a pipe section. The central placement of the swirl element permits an optimal distribution of the approaching gas mixture across the flow cross-section of the cylindrical catalyst body, which in this case is a circular cross-section.

In a particularly advantageous variant of the catalytic burner according to the invention, the swirl element occupies the entire cross-section of the line element and is placed at the end thereof that faces the transitional region. According to this variant, the swirl element therefore occupies the whole flow cross-section, so that the whole of the gas mixture is made to rotate and radially deflected. As a result, an optimum fanning of the gas mixture flow is obtained. Owing to the placement in the region of the line element that faces the transitional region and therefore the catalyst body, a very simple structure is created, because the swirl element can easily be installed as a termination of the line element between the transitional region and the line element.

In a further very useful and advantageous variant of the catalytic burner according to the invention, the flow cross-section widens between the swirl element and the catalyst body. This widening, which may in particular be provided in the transitional region, may have, for example, the shape of a funnel, so that a comparatively large flow cross-sectional area can be approached evenly. In addition, the velocity of the gas mixture is reduced by the widening of the cross section while the flow rate is maintained, so that the flow velocity and thus the dwell time of the gas mixture in the region of the catalyst body can be increased. This, also, reduces the overall size of the unit and the amount of catalytically active material in the region of the catalyst body. In this process, the swirl element fans the flow of the gas mixture in such a way that the gas is nevertheless distributed very evenly across the entire cross-section of the catalyst body in the region of the widening flow cross-section, because the gas flow, as mentioned several times, is suitably fanned by the swirl element.

In a highly advantageous variant of the catalytic burner according to the invention, guide elements and/or openings for the discharge of liquid are provided in the region of the cross-sectional widening on radially outward walls. The gas mixture may contain entrained liquid that reaches the region of the catalyst body and wets parts of the active surface, thereby interfering with the conversion of the gas. By radial fanning, however, the gas flow is given a swirl with which it flows through the region of the cross-sectional widening. As a result, any entrained fluid droplets are thrown outwards by centrifugal force and collect in the region of the walls of the cross-sectional widening. Here, suitable guide elements and/or openings can be provided through which the collected liquid can be discharged. In the walls upstream of the catalyst body, for example, a suitable groove can be provided in which liquid collects and is discharged from the region of the cross-sectional widening.

In an advantageous further development of the catalytic burner according to the invention, the line element is divided into at least two parallel sub-line elements upstream of the swirl element in the direction of flow by built-in parts extending in the direction of flow. This installation of guide elements, which is also described in the cited prior art, can in particular be used in curved line elements which carry the gas mixture into the region of the swirl element, in order to make the approach to the swirl element more even and the fanned flow significantly more homogeneous. If such built-in parts extending in the direction of flow and dividing the line element into at least two parallel sub-line elements are not used, a curved line element could cause an uneven approach to the swirl element, which in turn would result in an uneven approach to the catalyst body.

A particularly preferred application of the catalytic burner according to the invention in one of the variants described above is its use for the thermal conversion of combustible residues in the exhaust gases of a fuel cell. This particularly preferred application of the catalytic burner according to the invention permits the conversion of residues in the exhaust gases of a fuel cell, which typically contain hydrogen. In view of the fact that no hydrogen should be discharged into the environment and no combustible or explosive mixtures should leave the fuel cell system, the complete conversion of combustible residues in the exhaust gases of a fuel cell is subject to extremely stringent requirements. As a result, large catalyst bodies are required if this is to be reliably and safely ensured in all operating situations. By means of the structure of the catalytic burner according to the invention, however, the overall size of the catalyst body can be reduced as mentioned several times above. This is in particular critical in a use in a fuel cell, because a catalytic burner that is minimized in terms of space requirements and costs can nevertheless offer a safe and reliable complete conversion of all combustible residues in the exhaust gases. If the fuel cell or the fuel cell system equipped therewith is moreover used to provide electric drive power in vehicles, as known from general prior art, cost savings and the standard production runs of motor vehicle manufacture, which in the long term will certainly be reached in the manufacture of fuel cell vehicles as well, will offer significant savings in terms of costs and raw materials in the region of the catalytic burner.

In a further very useful and advantageous variant of the application of the catalytic burner according to the invention, additional fuel is added to the exhaust gas. In the fuel cell system, the material added for generating a hydrogen-containing gas for the fuel cell or the material added during the operation of the fuel cell with hydrogen would be hydrogen. This hydrogen could be added, for example, by ring injection, which is known as such from the prior art cited above. The gas mixture can be carried via the line element and the built-in parts extending therein, if provided, to the swirl element and can there be mixed with the existing gas mixture, which would typically be an exhaust air stream from a cathode region of the fuel cell and a hydrogen-containing gas residue from the anode region of the fuel cell. In this way, a gas mixture is created that contains comparatively large amounts of fuel and which can, if required for other applications, provide sufficient thermal energy from the catalytic burner.

In a particularly useful and advantageous further development of the application of the catalytic burner, the hot exhaust gases are expanded in a turbine downstream of the catalytic burner. Such a turbine for the recovery of compressive and thermal energy in the exhaust gases of fuel cell systems is likewise known from general prior art. The turbine can be connected either directly or indirectly to a compressor for the process air supplied to the fuel cell. The turbine and/or the compressor may in addition conceivably be coupled in an electric machine. This results in a structure that is commonly referred to as an electric turbocharger or ETC. In this structure, the residual energy from the region of the fuel cell can be used via the catalytic burner and converted into usable mechanical energy via the turbine. This then drives—at least partially—the compressor for the process air. Any power that is still required is delivered by the electric machine in motor mode. If the turbine delivers more power than the compressor requires, the electric machine can be used as a generator to convert this power into electric power. In this way, a highly dynamic operation of a vehicle can be achieved owing to the fact that the additional injection of fuel in the region of the catalytic burner temporarily generates very hot gases, which then make available so much energy via the turbine that additional electric energy can be provided via the electric machine in generator mode for driving the vehicle, for example when the fuel cell delivers no or insufficient electric energy.

Further advantageous variants of the catalytic burner can be derived from the embodiment which is explained in greater detail below with reference to the figures.

### BRIEF DESCRIPTION OF THE DRAWING FIGURES

Of the figures:

FIG. 1 is a diagrammatic cross-section through a catalytic burner according to the invention; and

FIG. 2 is a top view of a swirl element according to the invention.

### DETAILED DESCRIPTION

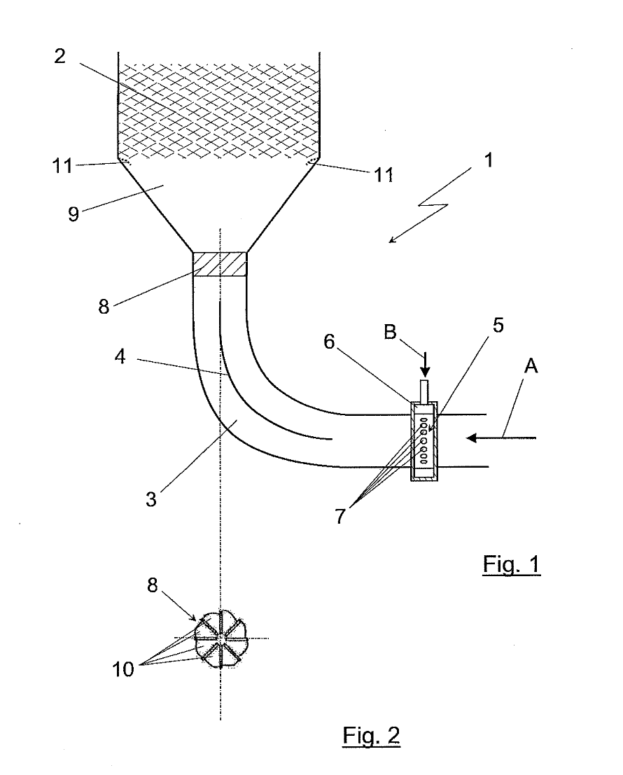

FIG. 1 is a diagrammatic cross-section through a catalytic burner 1. This essentially consists of a catalyst body 2 and a line element 3 that carries a gas mixture with combustible or convertible starting materials to the catalyst body 2. The starting materials may be, for example, the materials contained in the exhaust gases from a cathode compartment and an anode compartment of a fuel cell, in particular residual oxygen and residual hydrogen. In principle, the conversion of other combustible materials, such as hydrocarbons or the like, is also conceivable. The line element 3, which is curved in the illustrated embodiment, contains built-in parts 4 extending in the direction of flow, which ensure that, notwithstanding the curvature of the line element 3, the approaching gas mixture is distributed evenly across the cross-section of the line element 3 downstream of the curvature. The gas mixture approaching in accordance with arrow A may be a mixture of exhaust gases A from a cathode compartment and an anode compartment of a fuel cell. To this gas mixture, which is already combustible, additional fuel B can be added via a ring nozzle 5. This fuel B is introduced into the gas mixture A through the ring nozzle 5, which is known as such, in such a way that the fuel B flows from an annular chamber 6 via openings 7 distributed along the circumference of the line element 3 into the mixture. The gas mixture A, to which the fuel B has been optionally added, then flows through the line element 3, being guided evenly through the curvature of the line element 3 by the built-in parts 4, into the region of a swirl element 8 and from there through a transitional region 9 into the catalyst body 2.

As the top view of FIG. 2 shows, the swirl element 8 is provided with a plurality of guide vanes 10 in such a way that the gas mixture A flowing through the swirl element 8 is deflected radially. As a result, the gas mixture A is fanned and can be distributed very homogeneously and evenly across the flow area of the catalyst body 2 through the cross-section which widens in the transitional region 9. The swirl element 8 is very small and simple in design and can therefore be produced cost-effectively. Flow simulations have confirmed that both the gas distribution and the velocity profile across the catalyst body 2 could be evened out significantly in different load conditions by this simple and efficient swirl element 8. As a result, the available catalyst body 2 or the flow cross-section available in the catalyst body 2 is approached ideally and utilized optimally. The catalyst body 2 can therefore be designed to be very small and efficient. This is a significant advantage in terms of space requirements and costs and in terms of the required catalytically active material.

If liquid in the form of droplets is present in the gas mixture stream, this would wet at least a part of the surface of the catalyst body 2 and make it ineffective. To prevent this, suitable guide elements 11 and/or openings can be provided in the transitional region 9 in the region of the walls, for example in the region of the walls immediately before the catalyst body 2 is reached. In the gas mixture flow which is fanned across the cross-sectional area of the catalyst body 2 by the swirl element 8, the droplets are displaced outwards by centrifugal force. As a result, the liquid can be separated very efficiently and discharged from the region of the catalytic burner 1 via the guide elements 11 and, if provided, via discharge openings (not shown in the drawing) in the region of the walls of the transitional region 9.

As a whole, a very efficient and compact structure is provided, which permits, using very simple and cost-effective means, the available cross-sectional area of the catalyst body 2 to be approached optimally and therefore provides a structure of the catalyst body 2 which is very short in the direction of flow and therefore cost-effective.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A catalytic burner, comprising:
a catalyst body;
a line element configured to supply a gas mixture to the catalyst body;
a transitional region configured between the line element and the catalyst body; and
a swirl element configured in a flow region upstream of the catalyst body in a direction of flow, wherein the swirl element comprises a plurality of guide vanes.

12. The catalytic burner according to claim 11, wherein the catalyst body is cylindrical and the swirl element is arranged centrally with respect to a flow cross-section of the catalyst body.

13. The catalytic burner according to claim 11, wherein the swirl element occupies an entire cross-section of the line element and is placed at the end thereof that faces the transitional region.

14. The catalytic burner according to claim 12, wherein the flow cross-section widens between the swirl element and the catalyst body.

15. The catalytic burner according to claim 14, further comprising:
guide elements or openings configured to discharge of liquid, the guide elements or opening are configured a region of the cross-sectional widening on radially outward walls.

16. The catalytic burner according to claim 11, wherein the line element is divided into at least two parallel sub-line elements upstream of the swirl element in the direction of flow by built-in parts extending in the direction of flow.

17. The catalytic burner according to claim 11, wherein the catalytic burner is configured to thermally convert combustible residues in exhaust gases of a fuel cell.

18. The catalytic burner according to claim 17, wherein additional fuel is arranged to be added to the exhaust gases.

19. The catalytic burner according to claim 18, wherein hot gases are expanded in a turbine downstream of the catalytic burner.
